(19) United States
(12) Patent Application Publication
(10) Pub. No.: US 2015/0137855 A1
(43) Pub. Date: May 21, 2015

(54) Current To Voltage Converter

(71) Applicant: LSI Corporation, San Jose, CA (US)

(72) Inventors: Dong Hui Wang, Shanghai (CN); Zheng Xin Cao, Shanghai (CN); Shu Dong Cheng, Shanghai (CN); Yan Xu, Shanghai (CN); Jie Hao Xu, San Jose, CA (US); Ming Chen, Shanghai (CN)

(73) Assignee: LSI Corporation, San Jose, CA (US)

(21) Appl. No.: 14/146,209

(22) Filed: Jan. 2, 2014

Related U.S. Application Data
(60) Provisional application No. 61/906,901, filed on Nov. 21, 2013.

(51) Int. Cl. G05F 1/625

(52) U.S. Cl. CPC G05F 1/625
USPC 327/103

(57) ABSTRACT

An apparatus for converting current to voltage includes a pair of current inputs, a differential voltage output connected to the pair of current inputs, a current summing node connected to the pair of current inputs through a first resistor branch, a common mode feedback node connected to the pair of current inputs through a second resistor branch, an amplifier operable to generate a current control signal based at least in part on a voltage at the common mode feedback node, and a current controller operable to control a current through the current summing node based at least in part on the current control signal.

### CROSS REFERENCE TO RELATED APPLICATIONS

The present application claims priority to (is a non-provisional of) U.S. Pat. App. No. 61/906,901, entitled “Current To Voltage Converter”, and filed Nov. 21, 2013 by Wang et al, the entirety of which is incorporated herein by reference for all purposes.

### FIELD OF THE INVENTION

Various embodiments of the present invention provide apparatuses and methods for current to voltage conversion.

### BACKGROUND

A variety of electronic circuits and devices produce outputs that represent information as a varying electrical current, controlling the current level as a function of the information represented by the signal. However, many electronic circuits and devices for receiving and processing information have inputs requiring that information be represented as a function of varying electrical voltage rather than current. A current to voltage converter can be used as an interface between such circuits, receiving a current controlled signal and outputting a voltage controlled signal. A variety of different signal formats are commonly used for both current controlled signals and voltage controlled signals, complicating the design of current to voltage converters. For example, signals may be single-ended, using a single electrical conductor, with the value carried by the signal being interpreted by comparison to a reference value, or differential, with signals carried using a pair of electrical conductors, and with the value being interpreted by the difference between the value on each of the differential pair.

### BRIEF SUMMARY

Some embodiments of the present invention provide an apparatus for converting a current controlled input to a voltage controlled output, including a pair of current inputs, a differential voltage output connected to the pair of current inputs, a current summing node connected to the pair of current inputs through a first resistor branch, a common mode feedback node connected to the pair of current inputs through a second resistor branch, an amplifier operable to generate a current control signal based at least in part on a voltage at the common mode feedback node, and a current controller operable to control a current through the current summing node based at least in part on the current control signal.

This summary provides only a general outline of some embodiments according to the present invention. Many other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components.

FIG. 1 is a schematic diagram of a current to voltage converter with a single ended input and a differential output in accordance with some embodiments of the present invention;

FIG. 2 is a graph of the differential output voltage as a function of the single-ended input current to the current to voltage converter of FIG. 1 in accordance with some embodiments of the present invention;

FIG. 3 is a schematic diagram of a current to voltage converter with differential inputs and outputs in accordance with some embodiments of the present invention;

FIG. 4 is a graph of the differential output voltage as a function of the differential input current to the current to voltage converter of FIG. 3 in accordance with some embodiments of the present invention;

FIG. 5 is a schematic diagram of a current to voltage converter with a single ended input and a differential output, and including an operational transconductance amplifier, in accordance with some embodiments of the present invention;

FIG. 6 is a schematic diagram of a current to voltage converter with differential inputs and outputs, and including an operational transconductance amplifier, in accordance with some embodiments of the present invention;

FIG. 7 is a schematic diagram of a current to voltage converter with a single ended input and a differential output, and including an operational transconductance amplifier and a current steering digital to analog converter, in accordance with some embodiments of the present invention;

FIG. 8 is a schematic diagram of a current to voltage converter with differential inputs and outputs, and including an operational transconductance amplifier and a current steering digital to analog converter, in accordance with some embodiments of the present invention;

FIG. 9 is a schematic diagram of a current to voltage converter with a single ended input and a differential output including a p-channel transistor in accordance with some embodiments of the present invention; and

FIG. 10 depicts a flow diagram of an operation for converting a current to a differential voltage in accordance with one or more embodiments of the present invention.

### DETAILED DESCRIPTION OF THE INVENTION

A current to voltage converter is disclosed which can receive any current input, such as, but not limited to, a single ended or a differential current input, and which outputs a differential output voltage. In some embodiments, the differential output of the current to voltage converter has an adjustable common mode value. When receiving a single ended current input, the current to voltage converter continues to provide a differential output voltage with a stable common mode value.

Notably, the common mode value can be adjusted using an external reference voltage signal, or can have a programmed or hard wired value in various embodiments. The common mode value can thus be set at a stable, constant value, or can be varied during operation if desired.

Turning to FIG. 1, a schematic diagram depicts a current to voltage converter 100 with a single ended current input and a differential output voltage in accordance with some embodiments of the present invention. One current input 102 receives a reference current I, which in some embodiments has a constant current level, and which can be 0 Amps or a non-zero current level. Another current input 104 receives a current input I+ΔI, where ΔI is the varying current to be converted to a differential output voltage. In some embodiments, differential voltage outputs 116, 118 VOP, VON are connected to current inputs 102, 104.

One resistor branch includes a pair of resistors 106, 108, connected between current input 102 and voltage output 116 at one end and current input 104 and voltage output 118 at the other end. A current summing node 110 lies between resistors 106, 108. A tail current transistor 112 or other current control device is connected between current summing node 110 and a reference node 114 such as a ground. The tail current transistor 112 can be any current control device, such as, but not limited to, an n-channel field effect transistor. The currents I and I+ΔI received at inputs 102, 104 are summed at current summing node 110, yielding a tail current that flows through tail current transistor 112.

Another resistor branch includes a pair of resistors 120, 122, connected between voltage outputs 116, 118. A common mode feedback node 124 lies between resistors 120, 122. The voltage level at common mode feedback node 124 floats at a level controlled by the current through tail current transistor 112. While the resistors are not limited to any particular values, in some embodiments, resistors 106, 108, 120, 122 are 1 k Ohm resistors.

An amplifier 126 has one input connected to the common mode feedback node 124, and another input connected to a reference voltage source 128, and an output 130 connected to the control input or gate of the tail current transistor 112. The amplifier 126 can comprise any suitable device for measuring the difference between a common mode feedback voltage at common mode feedback node 124 and the reference voltage 128, such as, but not limited to, an operational amplifier, difference amplifier, etc.

The common mode voltage of differential voltage outputs 116, 118 is set by the reference voltage source 128. The amplifier 126 controls the tail current transistor 112, regulating the tail current through the summing node 110 to reduce the difference between the common mode feedback node 124 and the reference voltage 128. The common mode voltage of differential voltage outputs 116, 118 at the common mode feedback node 124 is thus set substantially at the same level as the reference voltage source 128.

In some embodiments, the reference voltage source 128 is an external control signal. In some other embodiments, the reference voltage source 128 is a programmable voltage source, for example using a register to contain the desired value and a digital to analog converter to control the voltage level of the reference voltage source 128 from the stored value in the register. In some other embodiments, the reference voltage source 128 is hard wired using any suitable voltage reference source, such as, but not limited to, a bandgap reference source, a diode-based reference source, a voltage divider, etc.

The resistor load is split in the current to voltage converter 100, providing one branch for common mode feedback, including resistors 120, 122 around common mode feedback node 124, and another branch for current summing, including resistors 106, 108 around current summing node 110. The voltage at differential voltage outputs 116, 118 is set by the voltage drop across the resistors 106, 108 and 120, 122, based on the currents at current inputs 102, 104 and on the voltage level of the reference voltage source 128 as it controls the tail current transistor 112. The common mode feedback node 124 and the summing node 110 can each be treated as virtual grounds, meaning that common mode feedback node 124 and summing node 110 have a different DC value or DC offset, but the same AC value, so the AC value can be treated as ‘0’, or grounds. In other words, the AC ground at common mode feedback node 124 and summing node 110 can be treated as a stable or unchanged value. Because nodes 124 and 110 are AC grounds, resistors 106, 120 can be treated as a parallel connection, and resistors 108, 122 can be treated as a parallel connection.

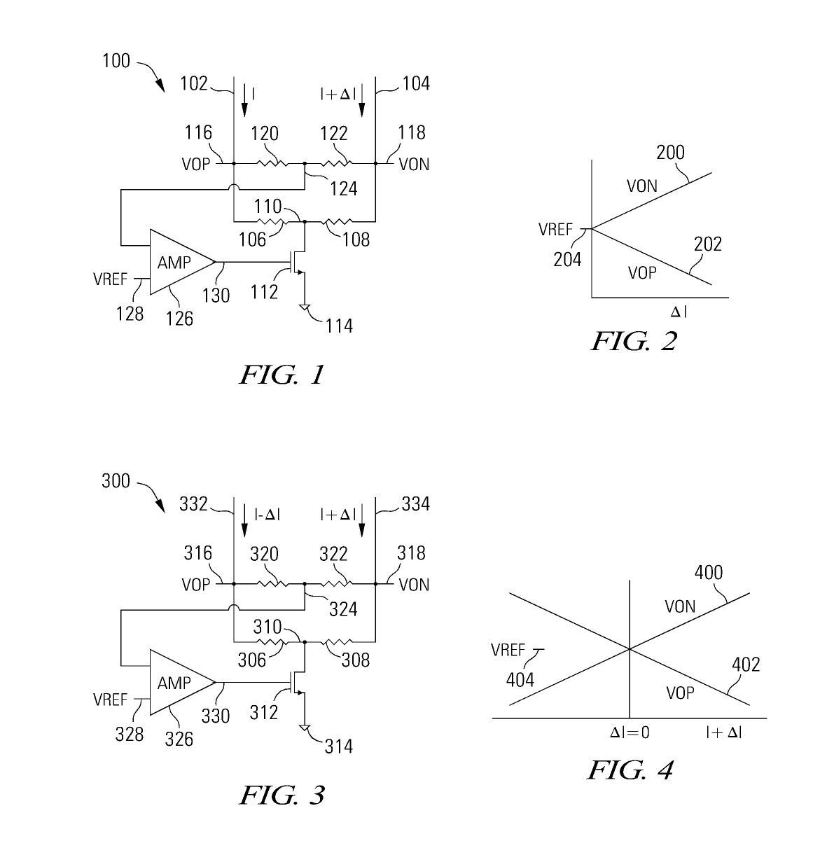

The current to voltage converter 100 thus can accept a single-ended current input and produce a differential output voltage with a stable common mode voltage. Turning to FIG. 2, a graph shows the differential voltage at differential voltage outputs 116, 118 as a function of the single-ended input current to the current to voltage converter 100 of FIG. 1 in accordance with some embodiments of the present invention. The common mode voltage is set by the reference voltage 128 at voltage level 204, with output voltages VON 200 and VOP 202 at differential voltage outputs 116, 118 symmetrically varying around the reference voltage level 204 as a function of the changing input current ΔI.

The common mode voltage is thus referred to herein as being stable, or controllable by reference voltage source 128, in contrast to conventional current to voltage converters that, given a single ended current input and differential output, would have a constant output voltage at one conductor of a differential output pair and a varying output voltage at the other conductor of a differential output pair. This would result in a changing common mode voltage that is the average of the constant output voltage and the varying output voltage.

The operation of some embodiments of the current to voltage converter 100 can be described by the following equations:

$$R 120 = R 122$$

$$R 106 = R 108$$

$$VON 118 - VOP 116 = \frac{R 120 * R 106}{R 120 + R 106} * Δ I$$

$$V 124 = VREF 128$$

$$VREF 128 - V 110 = R 106 * ( I + \frac{Δ I}{2} ) , ⇒ V 110 = VREF 128 - R 106 * ( I + \frac{Δ I}{2} )$$

$$VREF 128 = ( VOP 116 + VON 118 ) / 2$$

The current to voltage converter disclosed herein can accept both single-ended current inputs, as in the embodiment of FIG. 1, and differential current inputs. Turning to FIG. 3, a schematic diagram depicts a current to voltage converter 300 with a differential current input and a differential output voltage in accordance with some embodiments of the present invention. One current input 332 receives a current input I−ΔI, another current input 334 receives a current input I+ΔI. In some embodiments, differential voltage outputs 316, 318 VOP, VON are connected to current inputs 332, 334.

One resistor branch includes a pair of resistors 306, 308, connected between current input 332 and voltage output 316 at one end and current input 334 and voltage output 318 at the other end. A current summing node 310 lies between resistors 306, 308. A tail current transistor 312 or other current control device is connected between current summing node 310 and a reference node 314 such as a ground. The tail current transistor 312 can be any current control device, such as, but not limited to, an n-channel field effect transistor. The currents I−ΔI and I+ΔI received at inputs 332, 334 are summed at current summing node 310, yielding a tail current that flows through tail current transistor 312.

Another resistor branch includes a pair of resistors 320, 322, connected between voltage outputs 316, 318. A common mode feedback node 324 lies between resistors 320, 322. The voltage level at common mode feedback node 324 floats at a level controlled by the current through tail current transistor 312.

An amplifier 326 has one input connected to the common mode feedback node 324, and another input connected to a reference voltage source 328, and an output 330 connected to the control input or gate of the tail current transistor 312. The amplifier 326 can comprise any suitable device for measuring the difference between a common mode feedback voltage at common mode feedback node 324 and the reference voltage 328, such as, but not limited to, an operational amplifier, difference amplifier, etc.

The common mode voltage of differential voltage outputs 316, 318 is set by the reference voltage source 328. The amplifier 326 controls the tail current transistor 312, regulating the tail current through the summing node 310 to reduce the difference between the common mode feedback node 324 and the reference voltage 328. The common mode voltage of differential voltage outputs 316, 318 at the common mode feedback node 324 is thus set substantially at the same level as the reference voltage source 328.

In some embodiments, the reference voltage source 328 is an external control signal. In some other embodiments, the reference voltage source 328 is a programmable voltage source, for example using a register to contain the desired value and a digital to analog converter to control the voltage level of the reference voltage source 328 from the stored value in the register. In some other embodiments, the reference voltage source 328 is hard wired using any suitable voltage reference source, such as, but not limited to, a bandgap reference source, a diode-based reference source, a voltage divider, etc.

The resistor load is split in the current to voltage converter 300, providing one branch for common mode feedback, including resistors 320, 322 around common mode feedback node 324, and another branch for current summing, including resistors 306, 308 around current summing node 310. The voltage at differential voltage outputs 316, 318 is set by the voltage drop across the resistors 306, 308 and 320, 322, based on the currents at current inputs 302, 304, and on the voltage level of the reference voltage source 328 as it controls the tail current transistor 312.

The current to voltage converter 300 thus can accept a differential current input and produce a differential output voltage with a stable common mode voltage. Turning to FIG. 4, a graph shows the differential voltage at differential voltage outputs 316, 318 as a function of the differential input current to the current to voltage converter 300 of FIG. 3 in accordance with some embodiments of the present invention. The common mode voltage is set by the reference voltage 328 at voltage level 404, with output voltages VON 400 and VOP 402 at differential voltage outputs 316, 318 symmetrically varying around the reference voltage level 404 as a function of the changing differential input currents I−ΔI and I+ΔI.

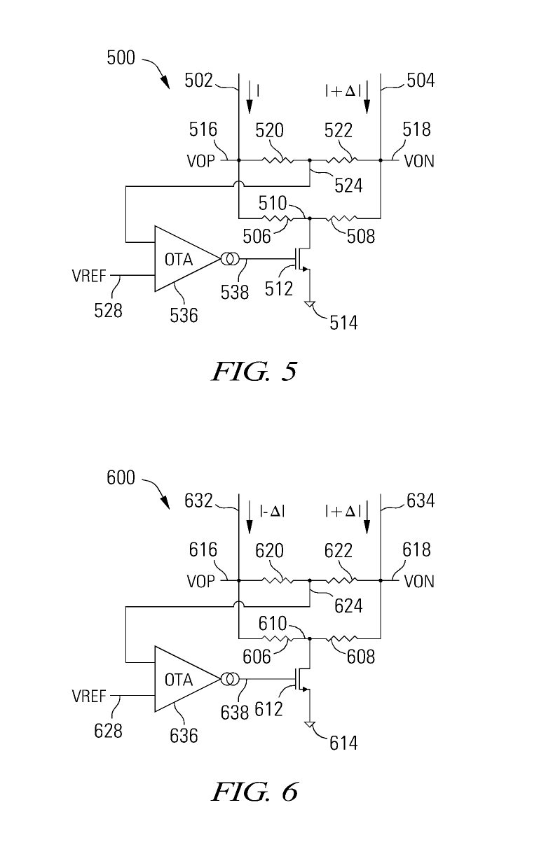

Turning to FIG. 5, a schematic diagram depicts a current to voltage converter 500 with a single ended current input and a differential output voltage in accordance with some embodiments of the present invention. In this embodiment, an operational transconductance amplifier 536 is used to drive the tail current transistor 512. One current input 502 receives a reference current I, which in some embodiments has a constant current level, and which can be 0 Amps or a non-zero current level. Another current input 504 receives a current input I+ΔI, where ΔI is the varying current to be converted to a differential output voltage. In some embodiments, differential voltage outputs 516, 518 VOP, VON are connected to current inputs 502, 504.

One resistor branch includes a pair of resistors 506, 508, connected between current input 502 and voltage output 516 at one end and current input 504 and voltage output 518 at the other end. A current summing node 510 lies between resistors 506, 508. A tail current transistor 512 or other current control device is connected between current summing node 510 and a reference node 514 such as a ground. The tail current transistor 512 can be any current control device, such as, but not limited to, an n-channel field effect transistor. The currents I and I+ΔI received at inputs 502, 504 are summed at current summing node 510, yielding a tail current that flows through tail current transistor 512.

Another resistor branch includes a pair of resistors 520, 522, connected between voltage outputs 516, 518. A common mode feedback node 524 lies between resistors 520, 522. The voltage level at common mode feedback node 524 floats at a level controlled by the current through tail current transistor 512.

An operational transconductance amplifier 536 has one input connected to the common mode feedback node 524, and another input connected to a reference voltage source 528, and an output 530 connected to the control input or gate of the tail current transistor 512. The operational transconductance amplifier 536 has voltage inputs and a high output impedance current output 538 suitable for driving the capacitive load of the gate of the tail current field effect transistor 512 with lower power consumption than some other types of amplifiers.

The common mode voltage of differential voltage outputs 516, 518 is set by the reference voltage source 528. The operational transconductance amplifier 536 controls the tail current transistor 512, regulating the tail current through the summing node 510 to reduce the difference between the common mode feedback node 524 and the reference voltage 528. The common mode voltage of differential voltage outputs 516, 518 at the common mode feedback node 524 is thus set substantially at the same level as the reference voltage source 528.

In some embodiments, the reference voltage source 528 is an external control signal. In some other embodiments, the reference voltage source 528 is a programmable voltage source, for example using a register to contain the desired value and a digital to analog converter to control the voltage level of the reference voltage source 528 from the stored value in the register. In some other embodiments, the reference voltage source 528 is hard wired using any suitable voltage reference source, such as, but not limited to, a bandgap reference source, a diode-based reference source, a voltage divider, etc.

The resistor load is split in the current to voltage converter 500, providing one branch for common mode feedback, including resistors 520, 522 around common mode feedback node 524, and another branch for current summing, including resistors 506, 508 around current summing node 510. The voltage at differential voltage outputs 516, 518 is set by the voltage drop across the resistors 506, 508 and 520, 522, based on the currents at current inputs 502, 504 and on the voltage level of the reference voltage source 528 as it controls the tail current transistor 512. The current to voltage converter 500 thus can accept a single-ended current input and produce a differential output voltage with a stable common mode voltage.

Turning to FIG. 6, a schematic diagram depicts a current to voltage converter 600 with a differential current input and a differential output voltage in accordance with some embodiments of the present invention. One current input 632 receives a current input I−ΔI, another current input 634 receives a current input I+ΔI. In some embodiments, differential voltage outputs 616, 618 VOP, VON are connected to current inputs 632, 634.

One resistor branch includes a pair of resistors 606, 608, connected between current input 632 and voltage output 616 at one end and current input 634 and voltage output 618 at the other end. A current summing node 610 lies between resistors 606, 608. A tail current transistor 612 or other current control device is connected between current summing node 610 and a reference node 614 such as a ground. The tail current transistor 612 can be any current control device, such as, but not limited to, an n-channel field effect transistor. The currents I−ΔI and I+ΔI received at inputs 632, 634 are summed at current summing node 610, yielding a tail current that flows through tail current transistor 612.

Another resistor branch includes a pair of resistors 620, 622, connected between voltage outputs 616, 618. A common mode feedback node 624 lies between resistors 620, 622. The voltage level at common mode feedback node 624 floats at a level controlled by the current through tail current transistor 612.

An operational transconductance amplifier 636 has one input connected to the common mode feedback node 624, and another input connected to a reference voltage source 628, and an output 630 connected to the control input or gate of the tail current transistor 612. The operational transconductance amplifier 636 has voltage inputs and a high output impedance current output 638 suitable for driving the capacitive load of the gate of the tail current field effect transistor 612 with lower power consumption than some other types of amplifiers.

The common mode voltage of differential voltage outputs 616, 618 is set by the reference voltage source 628. The operational transconductance amplifier 636 controls the tail current transistor 612, regulating the tail current through the summing node 610 to reduce the difference between the common mode feedback node 624 and the reference voltage 628. The common mode voltage of differential voltage outputs 616, 618 at the common mode feedback node 624 is thus set substantially at the same level as the reference voltage source 628.

In some embodiments, the reference voltage source 628 is an external control signal. In some other embodiments, the reference voltage source 628 is a programmable voltage source, for example using a register to contain the desired value and a digital to analog converter to control the voltage level of the reference voltage source 628 from the stored value in the register. In some other embodiments, the reference voltage source 628 is hard wired using any suitable voltage reference source, such as, but not limited to, a bandgap reference source, a diode-based reference source, a voltage divider, etc.

The resistor load is split in the current to voltage converter 600, providing one branch for common mode feedback, including resistors 620, 622 around common mode feedback node 624, and another branch for current summing, including resistors 606, 608 around current summing node 610. The voltage at differential voltage outputs 616, 618 is set by the voltage drop across the resistors 606, 608 and 620, 622, based on the currents at current inputs 602, 604, and on the voltage level of the reference voltage source 628 as it controls the tail current transistor 612. The current to voltage converter 600 thus can accept a differential current input and produce a differential output voltage with a stable common mode voltage.

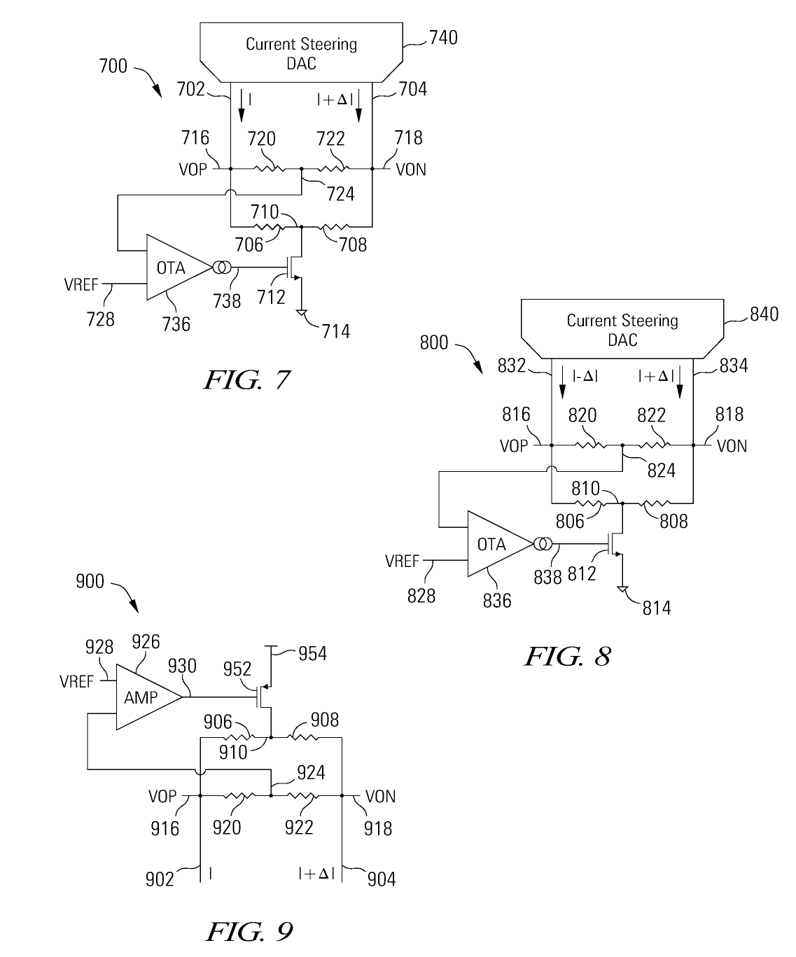

Turning to FIG. 7, a schematic diagram depicts a current to voltage converter 700 with a single ended current input and a differential output voltage in accordance with some embodiments of the present invention. In this embodiment, a current steering digital to analog converter (DAC) 740 provides the single ended current input 704 and reference current 702. One current input 702 receives the reference current I from the current steering digital to analog converter 740, which in some embodiments has a constant current level, and which can be 0 Amps or a non-zero current level. Another current input 704 receives a current input I+ΔI from the current steering digital to analog converter 740, where ΔI is the varying current to be converted to a differential output voltage. In some embodiments, differential voltage outputs 716, 718 VOP, VON are connected to current inputs 702, 704.

One resistor branch includes a pair of resistors 706, 708, connected between current input 702 and voltage output 716 at one end and current input 704 and voltage output 718 at the other end. A current summing node 710 lies between resistors 706, 708. A tail current transistor 712 or other current control device is connected between current summing node 710 and a reference node 714 such as a ground. The currents I and I+ΔI received at inputs 702, 704 are summed at current summing node 710, yielding a tail current that flows through tail current transistor 712.

Another resistor branch includes a pair of resistors 720, 722, connected between voltage outputs 716, 718. A common mode feedback node 724 lies between resistors 720, 722. The voltage level at common mode feedback node 724 floats at a level controlled by the current through tail current transistor 712.

An operational transconductance amplifier 736 has one input connected to the common mode feedback node 724, and another input connected to a reference voltage source 728, and an output 730 connected to the control input or gate of the tail current transistor 712. The operational transconductance amplifier 736 has voltage inputs and a high output impedance current output 738 suitable for driving the capacitive load of the gate of the tail current field effect transistor 712 with lower power consumption than some other types of amplifiers.

The common mode voltage of differential voltage outputs 716, 718 is set by the reference voltage source 728. The operational transconductance amplifier 736 controls the tail current transistor 712, regulating the tail current through the summing node 710 to reduce the difference between the common mode feedback node 724 and the reference voltage 728. The common mode voltage of differential voltage outputs 716, 718 at the common mode feedback node 724 is thus set substantially at the same level as the reference voltage source 728.

In some embodiments, the reference voltage source 728 is an external control signal. In some other embodiments, the reference voltage source 728 is a programmable voltage source, for example using a register to contain the desired value and a digital to analog converter to control the voltage level of the reference voltage source 728 from the stored value in the register. In some other embodiments, the reference voltage source 728 is hard wired using any suitable voltage reference source, such as, but not limited to, a bandgap reference source, a diode-based reference source, a voltage divider, etc.

The resistor load is split in the current to voltage converter 700, providing one branch for common mode feedback, including resistors 720, 722 around common mode feedback node 724, and another branch for current summing, including resistors 706, 708 around current summing node 710. The voltage at differential voltage outputs 716, 718 is set by the voltage drop across the resistors 706, 708 and 720, 722, based on the currents at current inputs 702, 704 and on the voltage level of the reference voltage source 728 as it controls the tail current transistor 712. The current to voltage converter 700 thus can accept a single-ended current input and produce a differential output voltage with a stable common mode voltage.

Turning to FIG. 8, a schematic diagram depicts a current to voltage converter 800 with a differential current input and a differential output voltage in accordance with some embodiments of the present invention. In this embodiment, a current steering digital to analog converter (DAC) 840 provides the differential current inputs 832, 834. One current input 832 receives a current input I−ΔI from the current steering digital to analog converter 840, another current input 834 receives a current input I+ΔI from the current steering digital to analog converter 840. In some embodiments, differential voltage outputs 816, 818 VOP, VON are connected to current inputs 832, 834.

One resistor branch includes a pair of resistors 806, 808, connected between current input 832 and voltage output 816 at one end and current input 834 and voltage output 818 at the other end. A current summing node 810 lies between resistors 806, 808. A tail current transistor 812 or other current control device is connected between current summing node 810 and a reference node 814 such as a ground. The tail current transistor 812 can be any current control device, such as, but not limited to, an n-channel field effect transistor. The currents I−ΔI and I+ΔI received at inputs 832, 834 are summed at current summing node 810, yielding a tail current that flows through tail current transistor 812.

Another resistor branch includes a pair of resistors 820, 822, connected between voltage outputs 816, 818. A common mode feedback node 824 lies between resistors 820, 822. The voltage level at common mode feedback node 824 floats at a level controlled by the current through tail current transistor 812.

An operational transconductance amplifier 836 has one input connected to the common mode feedback node 824, and another input connected to a reference voltage source 828, and an output 830 connected to the control input or gate of the tail current transistor 812. The operational transconductance amplifier 836 has voltage inputs and a high output impedance current output 838 suitable for driving the capacitive load of the gate of the tail current field effect transistor 812 with lower power consumption than some other types of amplifiers.

The common mode voltage of differential voltage outputs 816, 818 is set by the reference voltage source 828. The operational transconductance amplifier 836 controls the tail current transistor 812, regulating the tail current through the summing node 810 to reduce the difference between the common mode feedback node 824 and the reference voltage 828. The common mode voltage of differential voltage outputs 816, 818 at the common mode feedback node 824 is thus set substantially at the same level as the reference voltage source 828.

In some embodiments, the reference voltage source 828 is an external control signal. In some other embodiments, the reference voltage source 828 is a programmable voltage source, for example using a register to contain the desired value and a digital to analog converter to control the voltage level of the reference voltage source 828 from the stored value in the register. In some other embodiments, the reference voltage source 828 is hard wired using any suitable voltage reference source, such as, but not limited to, a bandgap reference source, a diode-based reference source, a voltage divider, etc.

The resistor load is split in the current to voltage converter 800, providing one branch for common mode feedback, including resistors 820, 822 around common mode feedback node 824, and another branch for current summing, including resistors 806, 808 around current summing node 810. The voltage at differential voltage outputs 816, 818 is set by the voltage drop across the resistors 806, 808 and 820, 822, based on the currents at current inputs 802, 804, and on the voltage level of the reference voltage source 828 as it controls the tail current transistor 812. The current to voltage converter 800 thus can accept a differential current input and produce a differential output voltage with a stable common mode voltage.

It should be noted that although the embodiments disclosed above include an n-channel field effect transistor, other suitable types of switches and polarities can be used. For example, turning to FIG. 9, a schematic diagram depicts a current to voltage converter 900 with a single ended current input and a differential output voltage and including a p-channel field effect transistor 952 in accordance with some embodiments of the present invention. The p-channel field effect transistor 952 is connected to a reference node 954 such as, but not limited to, a voltage source VDD. A pair of current inputs 902, 904 are at a lower voltage end of the current to voltage converter 900, and can be either single-ended or differential inputs as with other embodiments disclosed above.

One resistor branch includes a pair of resistors 906, 908, connected between current input 902 and voltage output 916 at one end and current input 904 and voltage output 918 at the other end. A current summing node 910 lies between resistors 906, 908. Transistor 952 or other current control device is connected between current summing node 910 and reference node 954.

Another resistor branch includes a pair of resistors 920, 922, connected between voltage outputs 916, 918. A common mode feedback node 924 lies between resistors 920, 922. An amplifier 926 has one input connected to the common mode feedback node 924, and another input connected to a reference voltage source 928, and an output 930 connected to the control input or gate of the transistor 952. The amplifier 926 can comprise any suitable device for measuring the difference between a common mode feedback voltage at common mode feedback node 924 and the reference voltage 928, such as, but not limited to, an operational amplifier, difference amplifier, etc.

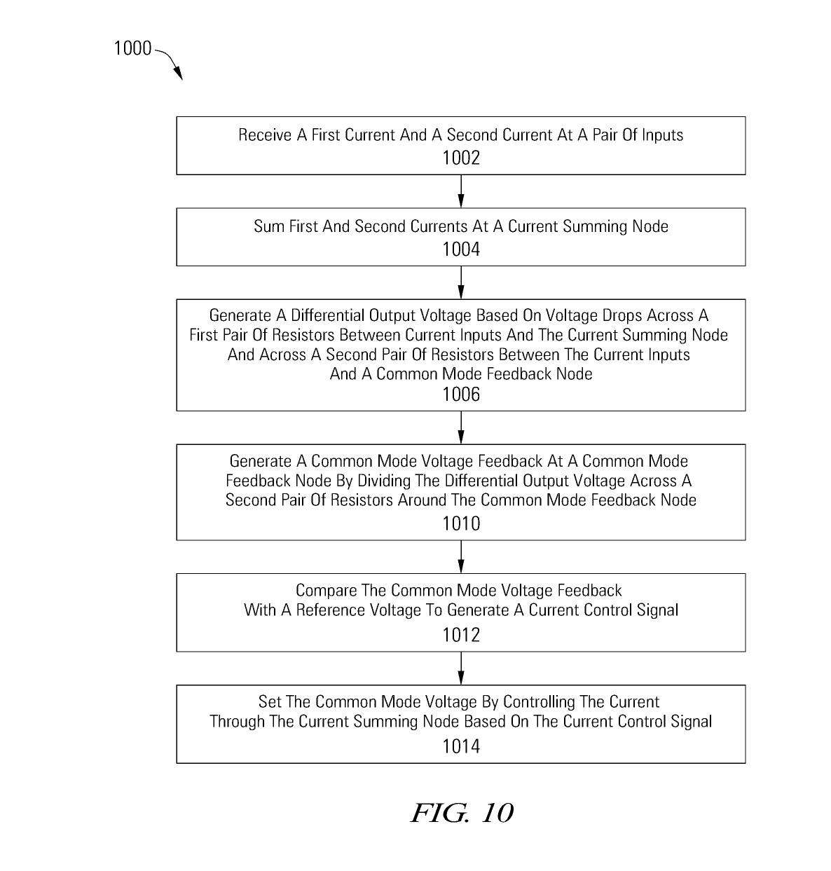

Turning to FIG. 10, a flow diagram 1000 depicts a method for current to voltage conversion in accordance with one or more embodiments of the present invention. Following flow diagram 1000, a first current and a second current are received at a pair of inputs. (Block 1002) In some embodiments, the input currents are received as a differential signal, with the first conductor of a differential pair input carrying the first current that can be represented as I+ΔI, and with the second conductor carrying the second current that can be represented as I−ΔI. In some other embodiments, the input currents are received as a single ended signal, with the first current being the input current ΔI received on the first of the pair of inputs, and with the second current being a reference current I received on the second of the pair of inputs. In some embodiments, the first current and the second current are obtained from a current steering digital to analog converter.

The first and second currents are summed at a current summing node. (Block 1004) In some embodiments, the first current and second current are added by combining them both at a current summing node. The current through the current summing node passes through a tail current transistor or other current controller.

A differential output voltage is generated based on voltage drops across a first pair of resistors between the current inputs and the current summing node and across a second pair of resistors between the current inputs and a common mode feedback node. (Block 1006) The first voltage in the differential pair of output voltages is generated by passing the first current through one of the first pair of resistors between the first current input and the current summing node. The second voltage in the differential pair of output voltages is generated by passing the second current through the other of the first pair of resistors between the second current input and the current summing node.

A common mode voltage feedback is generated at the common mode feedback node by dividing the differential output voltage across the second pair of resistors around the common mode feedback node. (Block 1010)

The common mode voltage feedback is compared with a reference voltage to generate a current control signal. (Block 1012) In some embodiments, the common mode voltage feedback and reference voltage are compared using an amplifier providing an output based on the difference between the common mode voltage feedback and reference voltage. In some embodiments, the amplifier is an operational transconductance amplifier. The reference voltage is obtained in some embodiments as an external control signal. In some other embodiments, the reference voltage is a programmable value, for example using a register to contain the desired value and a digital to analog converter to generate the reference voltage from the stored value in the register. In some other embodiments, the reference voltage is hard wired using any suitable voltage reference source, such as, but not limited to, a bandgap reference source, a diode-based reference source, a voltage divider, etc.

The common mode voltage is set by controlling the current through the current summing node based on the current control signal. (Block 1014) The current through the current summing node is controlled by the current control signal using the tail current transistor, such that the common mode voltage feedback is substantially equal to the reference voltage.

The current to voltage conversion disclosed herein is thus capable of receiving any current input, including single ended current inputs and differential current inputs, generating a differential output voltage with stable and controllable common mode voltage.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, embodiments of the present invention provide novel systems, devices, methods and arrangements for current to voltage conversion. While detailed descriptions of one or more embodiments of the invention have been given above, various alternatives, modifications, and equivalents will be apparent to those skilled in the art without varying from the spirit of the invention. Therefore, the above description should not be taken as limiting the scope of embodiments of the invention which are encompassed by the appended claims.

1. An apparatus for converting current to voltage, comprising:
a pair of current inputs;
a differential voltage output connected to the pair of current inputs;
a current summing node connected to the pair of current inputs through a first resistor branch, wherein a current through the current summing node is equal to a current through a first of the pair of current inputs plus a current through a second of the pair of current inputs;
a common mode feedback node connected to the pair of current inputs through a second resistor branch;
an amplifier operable to generate a current control signal based at least in part on a voltage at the common mode feedback node; and
a current controller operable to control a current through the current summing node based at least in part on the current control signal.

2. The apparatus of claim 1, wherein the amplifier is operable to compare the voltage at the common mode feedback node with a reference voltage.

3. The apparatus of claim 2, wherein the voltage at the common mode feedback node is substantially equal to the reference voltage.

4. The apparatus of claim 2, wherein the voltage at the common mode feedback node comprises a common mode voltage of the differential voltage output.

5. The apparatus of claim 1, wherein the amplifier comprises an operational transconductance amplifier.

6. The apparatus of claim 1, wherein the first resistor branch comprises a first resistor connected between a first of the pair of current inputs and the current summing node, and a second resistor connected between a second of the pair of current inputs and the current summing node.

7. The apparatus of claim 6, wherein the first resistor and the second resistor have a same resistance.

8. The apparatus of claim 1, wherein the second resistor branch comprises a first resistor connected between a first terminal of the differential voltage output and the common mode feedback node, and a second resistor connected between a second terminal of the differential voltage output and the common mode feedback node.

9. The apparatus of claim 8, wherein the first resistor and the second resistor have a same resistance.

10. The apparatus of claim 1, wherein the current controller is connected between the current summing node and a reference node.

11. The apparatus of claim 1, wherein the current controller comprises a field effect transistor.

12. The apparatus of claim 11, wherein a gate of the field effect transistor is connected to the current control signal.

13. The apparatus of claim 1, wherein the pair of current inputs comprises a single ended current input signal and a reference current signal.

14. The apparatus of claim 1, wherein the pair of current inputs comprises a differential current input.

15. The apparatus of claim 1, wherein the differential voltage output comprises a stable common mode voltage whether the pair of current inputs receives a single ended current input or a differential current input.

16. The apparatus of claim 1, wherein there is a DC voltage offset between the current summing node and the common mode feedback node during operation.

17. The apparatus of claim 1, wherein the current summing node and the common mode feedback node have a same AC voltage during operation.

18. The apparatus of claim 1, further comprising a current steering digital to analog converter connected to the pair of current inputs.

19. A method of converting a current input to a differential voltage output, comprising:
receiving a first current and a second current at a pair of current inputs;
summing the first current and the second current at a current summing node, wherein a current through the current summing node is equal to the first current plus the second current;
generating a differential output voltage based on voltage drops across a first pair of resistors connected between the pair of current inputs and the current summing node and across a second pair of resistors connected between the pair of current inputs and a common mode feedback node;
generating a common mode voltage feedback at the common mode feedback node by dividing the differential output voltage across the second pair of resistors connected between the pair of current inputs and the common mode feedback node;
comparing the common mode voltage feedback with a reference voltage to generate a current control signal; and
setting the common mode voltage by controlling a total current through the current summing node based on the current control signal.

20. A current to voltage converter, comprising:
a current steering digital to analog converter;
a pair of current inputs connected to the current steering digital to analog converter;
a differential voltage output connected to the pair of current inputs;
a first resistor connected between a first of the pair of current inputs and a current summing node;
a second resistor connected between a second of the pair of current inputs and the current summing node, wherein a current through the current summing node is equal to a current through a first of the pair of current inputs plus a current through a second of the pair of current inputs;
a third resistor connected between the first of the pair of current inputs and a common mode feedback node;
a fourth resistor connected between the second of the pair of current inputs and the common mode feedback node;
a transistor connected between the current summing node and a reference node; and
an amplifier having a first input connected to the common mode feedback node, a second input connected to a reference voltage, and an output connected to a gate of the transistor.
